(19) United States
(12) Patent Application Publication
(10) Pub. No.: US 2006/0057918 A1
(43) Pub. Date: Mar. 16, 2006

(54) Water resistant thermal insulating material and method of use

(76) Inventor: David M. Burnett, Salt Lake City, UT (US)

Correspondence Address: Todd E. Zenger;KIRTON & McCONKIE, 1800 Eagle Gate Tower, 60 East South Temple, Salt Lake City, UT, 84111, US

(21) Appl. No.: 11/225,549

(22) Filed: Sep. 13, 2005

Related U.S. Application Data
(60) Provisional application No. 60/609,630, filed on Sep. 14, 2004.

(51) Int. Cl. B32B 5/02; B32B 27/04; B32B 27/12; B32B 15/14

(52) U.S. Cl. 442/132; 442/131; 442/79; 442/170; 442/376; 442/378

(57) ABSTRACT

The present invention is directed to a material, or articles made from the material, which provide water resistance and thermal insulation and may be reversible.

### BACKGROUND

1. Related Applications

This application claims priority to U.S. Provisional Patent Application No. 60/609,603, filed Sep. 14, 2004, entitled A Water Resistant Thermal Insulating Material and Method of Use.

2. Background of the Invention and Related Art

The present invention relates to a thermally protective material, and its application in connection with clothing and outdoor gear including, but not limited to, sleeping hag covers and liners, sunscreens and outdoor clothing.

The present invention provides for a material that is lightweight, wind-,water-, chemical-, puncture-, tear-, stain- and abrasion-resistant and breathable (micro porous). The material is also strong, durable, and offers environmental resistance characteristics helpful in maintaining a comfortable (warm, cool, dry) physical environment when applied to various outdoor situations, including but not limited to ponchos, sleeping bag covers and liners, bivy sacs, sunscreens and protective clothing including hats, shirts/jackets, pants, mittens or gloves, booties and ponchos in wet or cold environments and, when reversed, extremely sunny environments and as a protective layer in all the same, where applicable.

Most fabrics/materials in use today for the above applications offer only one or a few of the above stated characteristics. Numerous materials and processes to create such materials have been developed in attempts to incorporate the above-stated characteristics into products that will help provide protection and comfort in cold, wet and/or hot/sunny environments commonly experienced while engaging in outdoor activities such as camping, hunting, hiking, climbing, skiing, fishing, etc.

Traditional single layer, uncoated, woven materials including, but not limited to, cotton, canvas, silk, nylon and polyester are breathable and may offer some wind resistance and protection from abrasion in the present application. They are not water repellent, thermally reflective or stain resistant, and they will absorb water and thus get heavy when wet and must be dried before further use. Coating these traditional fabrics with polyurethane or silicone-type substances, for example, for water repellency or stain resistance will increase their cost and weight and may reduce their breathability. Even when coated, traditional fabrics offer only a small degree of warmth, and they do not hold a thermally reflective coating well.

Non-woven materials commonly found in use as rain gear, tarps and ground covers such as polyvinyl chloride (PVC), polyethylene and polyester certainly repel wind and may afford a small degree of warmth in that they hold in some body heat when wrapped around you. The original NRC Space Blanket was an aluminized, multi-layered synthetic protective covering carried by many emergency response teams and ambulances for victims of emergencies, protecting them from hypothermia and shock. It was also touted for use as an emergency tent and sleeping bag, and was very durable but heavy.

The inexpensive emergency blankets commonly found in sporting goods stores and emergency supplies outlets that fold up and fit in a shirt pocket are aluminum coated polyester. These blankets are fairly effective at resisting water and wind. They are also extremely lightweight and are thermally reflective, providing some protection from extreme environments. However, the material from which these blankets are made is very fragile—tearing into pieces with the smallest cut or puncture, and thus are not truly reliable in an emergency.

Additionally, none of the non-woven materials mentioned above are breathable. This is a very desirable, even critical quality of outdoor sleepwear and protective clothing. If water vapor from the body is not allowed to escape, it will condense in those fabrics and in layers of insulation, reducing their effectiveness and increasing wearer/sleeper discomfort.

Other materials for making outdoor clothing, gear, etc. that is water resistant and breathable are available, but are much more expensive. Additionally, these materials do not exhibit all of the desirable characteristics of the current material, or are designed for entirely different applications such as weatherization membranes for buildings or as covers for automobiles, recreational vehicles and outdoor appliances.

### SUMMARY AND OBJECTS OF THE INVENTION

The present material has a superior combination of advantages, taken as a whole, over other materials in current use for the present applications: 1) it is very light (in one embodiment, it weighs only 1.75 ounces per square yard, thus, a sleeping bag cover or liner made from this material would weigh approximately nine ounces); 2) it is hydrophobic, which means it actually repels water (this material can be submerged in water then taken out and hung up so the water drains off, or wiped off and weighed, and its weight will not have changed over that of the original dry material); 3) this material reflects 40% more body heat than the same material when uncoated, and will increase the effective downward comfort range of a given sleeping bag by approximately twenty degrees Fahrenheit and dramatically reduce “cold spots” commonly experienced in rectangular sleeping bags; 4) this material shows no sign of degradation when buried in soil for an extended period; 5) this material is chemically inert to most acids, bases and salts; 6) this material will maintain 50% of its tensile strength after two years of extreme worst case UV exposure to its uncoated side; and 7) this material is breathable (e.g. in one embodiment, it allows for water vapor to pass through at 225 grams per square meter per 12 hours), which means body water vapor won't collect and condense on or in the sleeping hag, jacket, bootie, etc., reducing it's insulating effect and making the user feel “clammy”.

It is noted that the present invention is considered to have two embodiments: 1) the material itself (hereinafter “the Material”); and 2) the Material incorporated into a variety of novel uses. Additionally, the Material incorporated into various novel uses and applications is considered to be inventive as well.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings.

In all diagrams, the gray shaded areas represent the reflective, in this case aluminum, coating or layer of the Material, which can be worn (utilized) toward or away from the user, depending on the protection needed.

FIG. 1 is a depiction of the Material. The top (thin) layer in this embodiment is deposited aluminum. The bottom (hatched) layer is spun-bonded olefin.

FIG. 2 shows a sleeping bag cover (or bivy sac) made of the Material according to one embodiment of the present invention.

FIG. 3 shows the cover of FIG. 2 placed around a sleeping bag.

FIG. 4 shows cutaway depiction of a jacket wherein the Material is an integral layer of its construction.

FIG. 5 shows a simple rectangular bag made of the Material.

FIG. 6 shows a hat made of the Material.

FIG. 7 shows a hat made of the Material reflecting the sun's rays.

FIG. 8 shows a mitten (or glove or bootie) made of the Material with the reflective layer toward the skin.

FIG. 9 shows a cutaway depiction of the mitten of FIG. 8. In this embodiment, the Material is an integral layer of the mitten's construction.

FIG. 10 shows a poncho made of the Material. In this embodiment, the poncho is shown with the reflective layer on the inside.

FIG. 11 shows the poncho of FIG. 10 with the reflective layer outward.

FIG. 12 depicts the reflection of the thermal radiation (in this case sunlight) from the reflective layer according to one embodiment of the present invention.

FIG. 13 shows a long-sleeved shirt made of the Material.

FIG. 14 shows the shirt of FIG. 13, only with the reflective layer worn away from the skin.

FIG. 15 depicts the reflection of the thermal radiation (in this case sunlight) from the reflective layer of a shirt according to one embodiment of the present invention.

FIG. 16 shows a balaclava made of the Material.

### DETAILED DESCRIPTION OF THE PREFERRED EMBODIMENTS

It will be readily understood that the embodiments of the present invention, as generally described and illustrated in the figures herein, could be arranged and designed in a wide variety of different configurations. Thus, the following more detailed description of the embodiments of the system and method of the present invention is not intended to limit the scope of the invention, as claimed, but is merely representative of the presently preferred embodiments of the invention.

For the purpose of promoting an understanding of some of the principles of the illustrated embodiment(s), reference will now be made to exemplary embodiment(s) that are illustrated in the figures, and specific language will be used to describe the same. It will nevertheless be understood that no limitation of the scope of the claims is thereby intended. Any alterations and further modifications of the inventive feature(s) illustrated herein, and any additional applications of these principles, are considered within the scope of this invention.

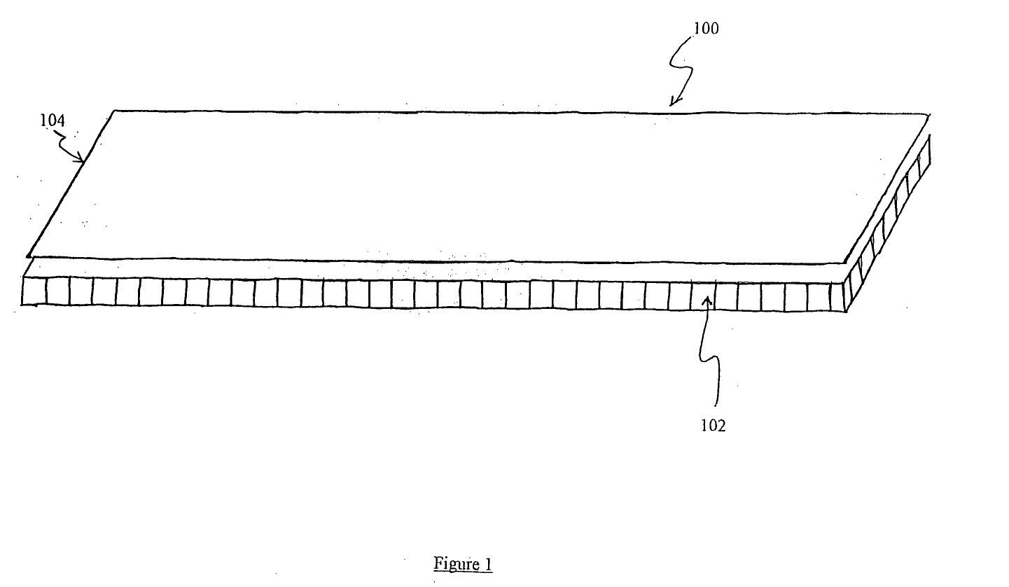

FIG. 1 is a sectional view of the Material 100 according to one embodiment of the present invention. The Material 100 comprises two parts: 1) a lightweight, wind-, water-, chemical-, puncture-, tear-, stain- and abrasion-resistant breathable (micro porous) underlying layer 102; and 2) a thermally reflective coating 104 disposed thereon.

In one embodiment, the underlying layer 102 is non-woven olefin. Such olefins are typically spunbonded and/or microporous. For example, some sources of olefin that are suitable for use as layer 102 with the present invention include, but are not limited to:

Tyvek and ProShield Nexgen by DuPont

Thinsulate by 3M

Duraguard by Kimberly-Clark

Evolution, Evolution III, KleenGuard, Block-It, Duslop, and Noah by Kimberly Clark

Typar by Reemay, Inc.

NS ActivGard 100, 200, 300 and LX (NS Northern Safety)

In one embodiment, the thermally reflective coating 104 is an aluminum vacuum coating. However, other types of reflective coating include, but are not limited to, gold and silver.

The inclusion of an underlying layer 102 as well as a reflective coating 104 allows the present invention (i.e. the Material 100 and/or any articles made therefrom) to protect a user from wet or cold environments (e.g. when worn with the reflective side on the inside). Additionally, the Material 100, and articles made therefrom, can protect a user from extremely sunny environments (e.g. when worn with the reflective side on the outside).

It is also noted that coating olefin with a reflective coating, as opposed to more traditional fabrics, is advantageous because, as already noted, olefin is breathable, yet water resistant. Additionally, more traditional fabrics offer only a small degree of warmth and will not hold a thermally reflective coating well because they flex and stretch too much.

The Material 100 of the present invention has a superior combination of advantages, taken as a whole, over (all) other materials in current use for the present applications. As note above, it is very light, weighing only 1.75 ounces per square yard in one embodiment. It is hydrophobic, which means it actually repels water. This material can be submerged in water then taken out and hung up so the water drains off, or wiped off and weighed, and its weight will not have changed over that of the original dry material. This material reflects 40% more body heat than the same material when uncoated, and will increase the effective downward comfort range of a given sleeping hag by approximately twenty degrees Fahrenheit and dramatically reduce “cold spots” commonly experienced in rectangular sleeping bags. This material shows no sign of degradation when buried in soil for an extended period. It is chemically inert to most acids, bases and salts. It will maintain 50% of its tensile strength after two years of extreme worst case UV exposure to its uncoated side. Perhaps most importantly, this material is breathable. It allows for water vapor to pass through at 225 grams per square meter per 12 hours, which means such body water vapor won't collect and condense on it and wet your sleeping bag (jacket, bootie, dc), reducing it's insulating effect and making you feel “clammy”.

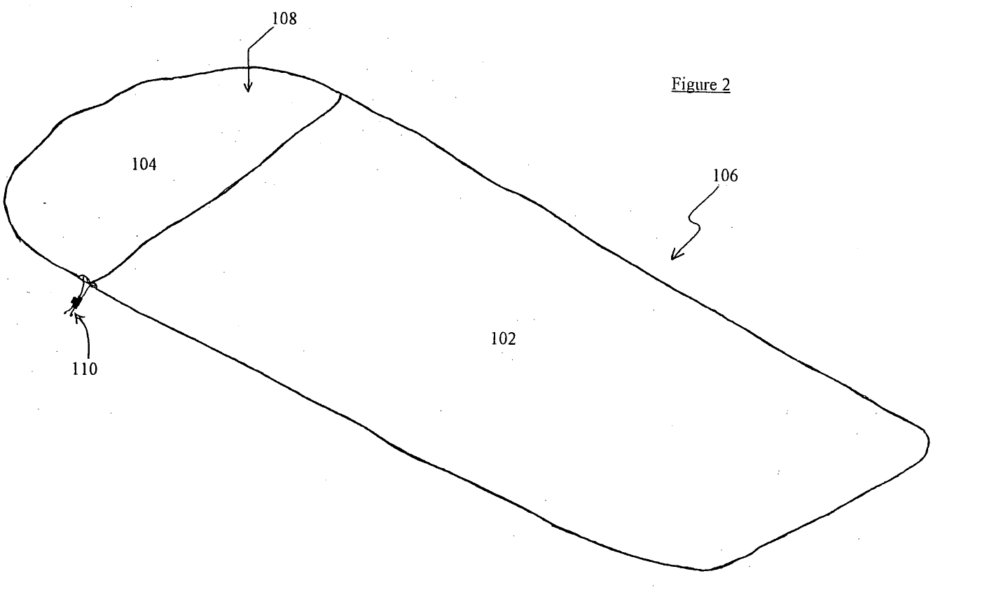

FIG. 2 shows a sleeping bag cover (or bivy sac) 106 made of the Material 100 with hood 108 and drawstring 110, allowing more complete closure and protection to the sleeper.

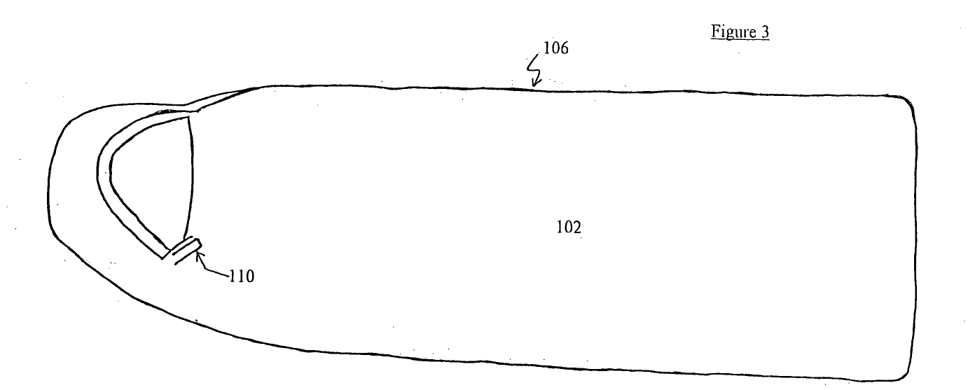

FIG. 3 shows the cover of FIG. 2 placed around a sleeping bag (not shown), adding additional breathable warmth and protection from water/dirt to the sleeper.

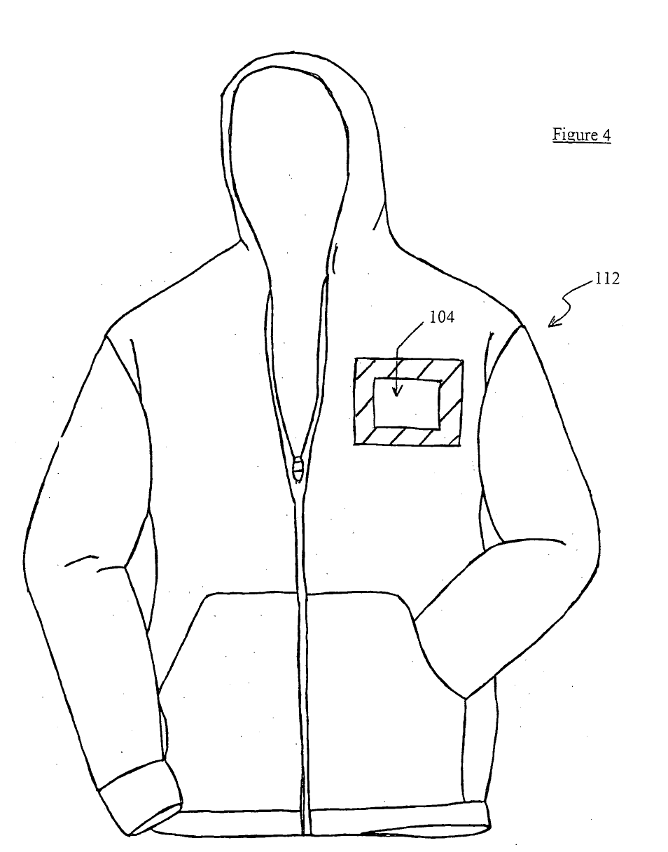

FIG. 4 shows cutaway depiction of a jacket 112 wherein the Material 100 is an integral layer of its construction, lending warmth with breathability.

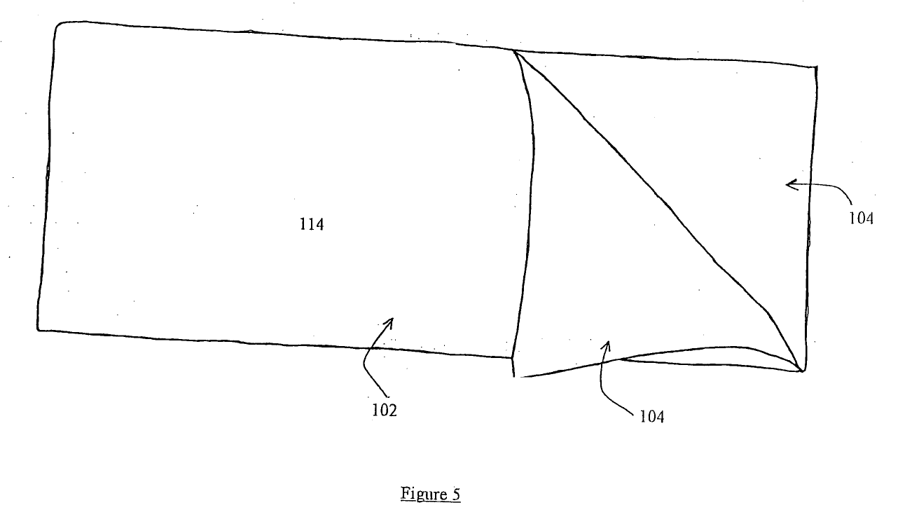

FIG. 5 shows a simple rectangular bag 114 made of the Material.

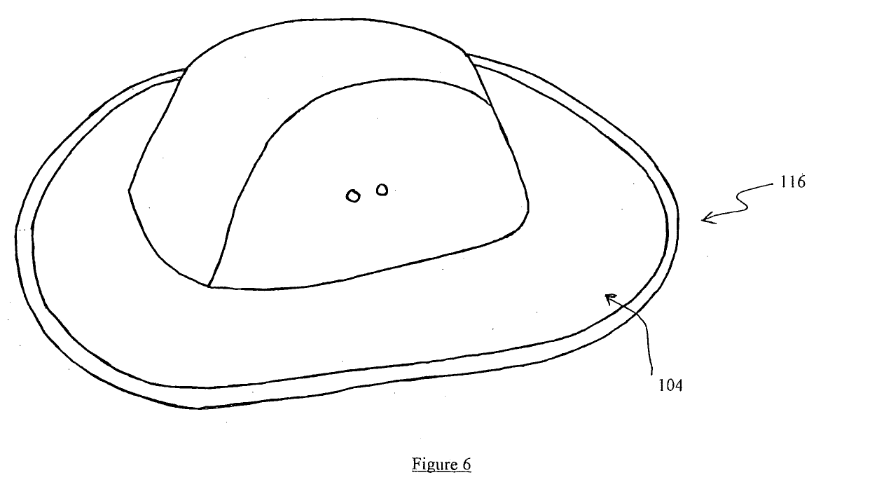

FIG. 6 shows a hat 116 made of the Material 100.

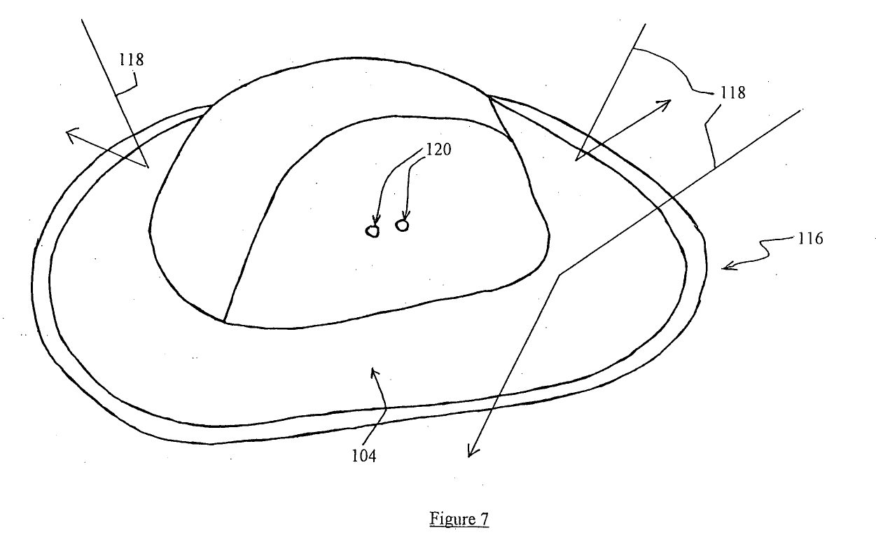

FIG. 7 shows a hat 116 made of the Material 100 reflecting the sun's rays 118, keeping the wearer cooler than with normal headwear. In addition to the breathability of the Material, this embodiment also includes ventilation holes 120 that contribute to the wearer's comfort.

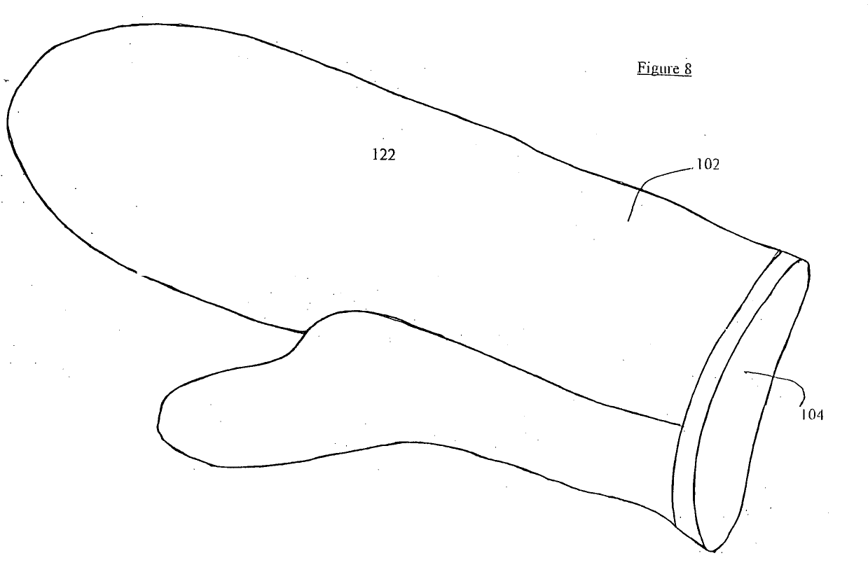

FIG. 8 shows a mitten (or glove or bootie) 122 made of the Material 100 with the reflective layer 104 toward the skin. It is noted that in this embodiment, the mitten could be worn as additional protection while sleeping or under another mitten/glove as an additional protective layer.

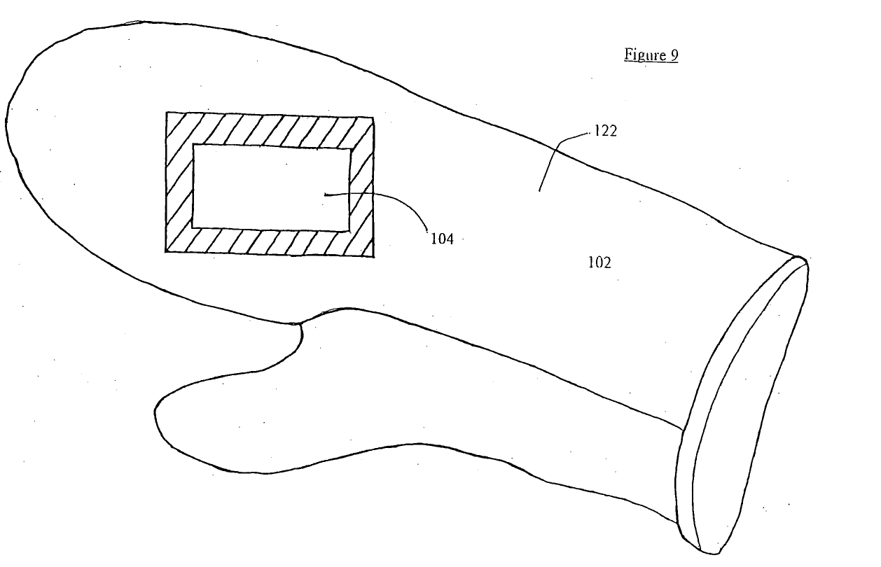

FIG. 9 shows a cutaway depiction of the mitten 122 of FIG. 8. In this embodiment, the Material 100 is an integral layer of the mitten's construction, lending warmth with breathability.

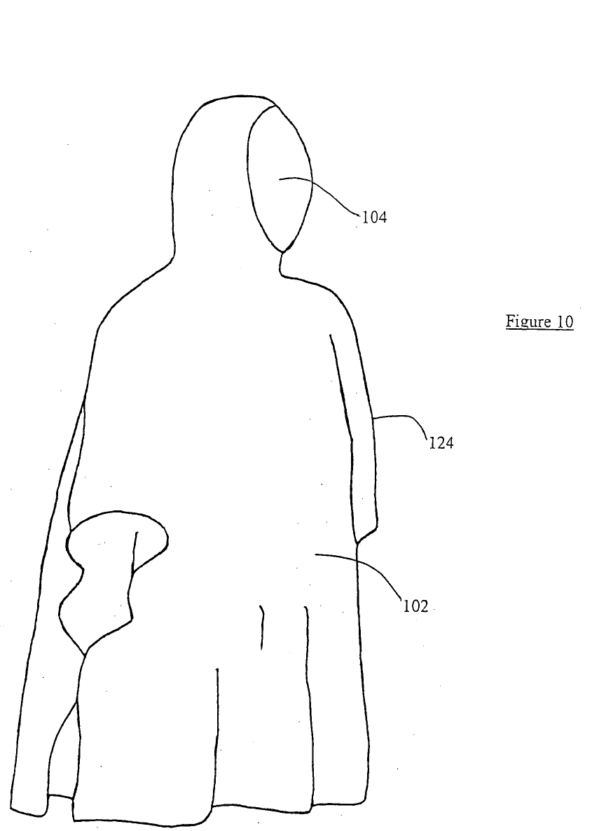

FIG. 10 shows a poncho 124 made of the Material 100. In this embodiment, the poncho is shown with the reflective layer 104 on the inside for additional warmth while the hydrophobic properties of the uncoated side repel rain/snow/wind.

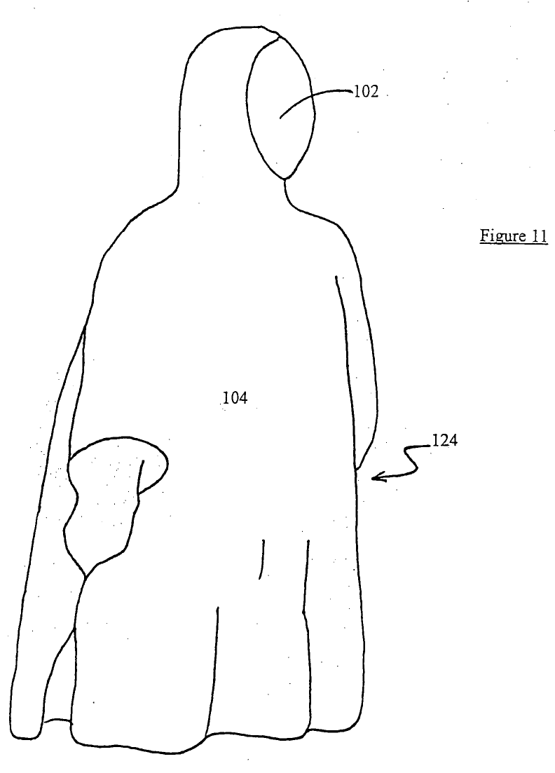

FIG. 11 shows the poncho 124 of FIG. 10 with the reflective layer 104 outward, reflecting the sun's intense rays and keeping the wearer cooler.

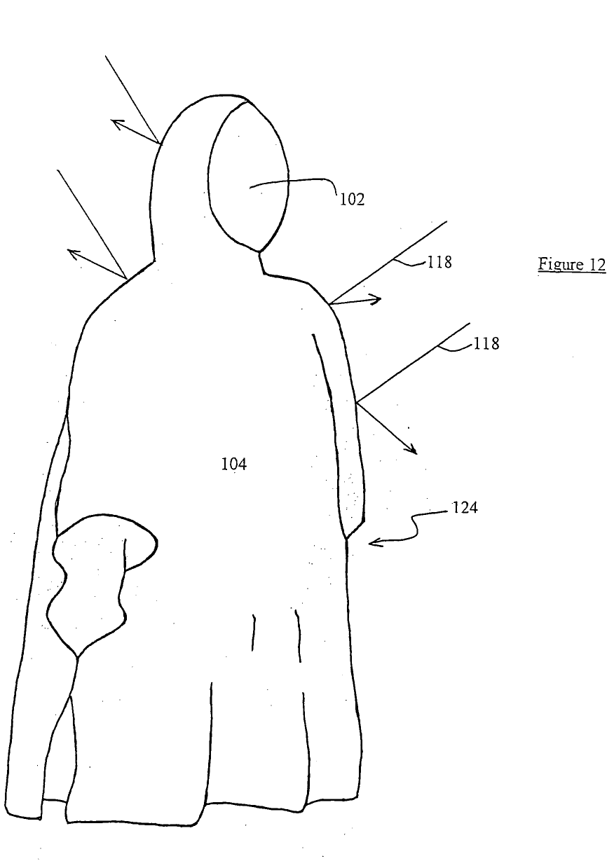

FIG. 12 depicts the reflection of the thermal radiation (in this case sunlight) 118 from the reflective layer 104 according to one embodiment of the present invention.

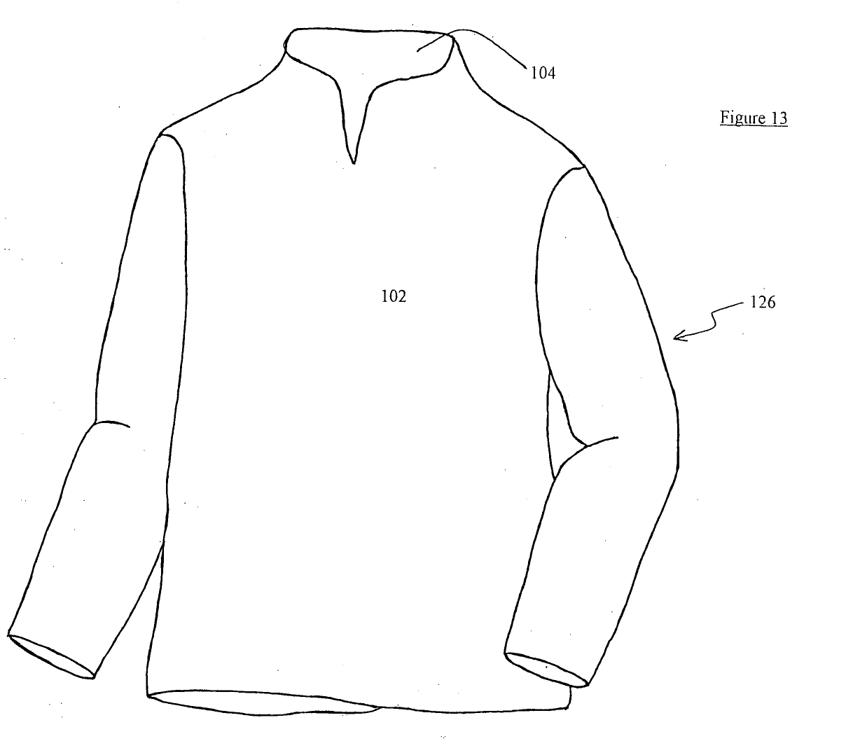

FIG. 13 shows a long-sleeved shirt 126 made of the Material 100 worn separately or over/under other outerwear with the reflective layer 104 worn towards the skin, adding warmth with breathability.

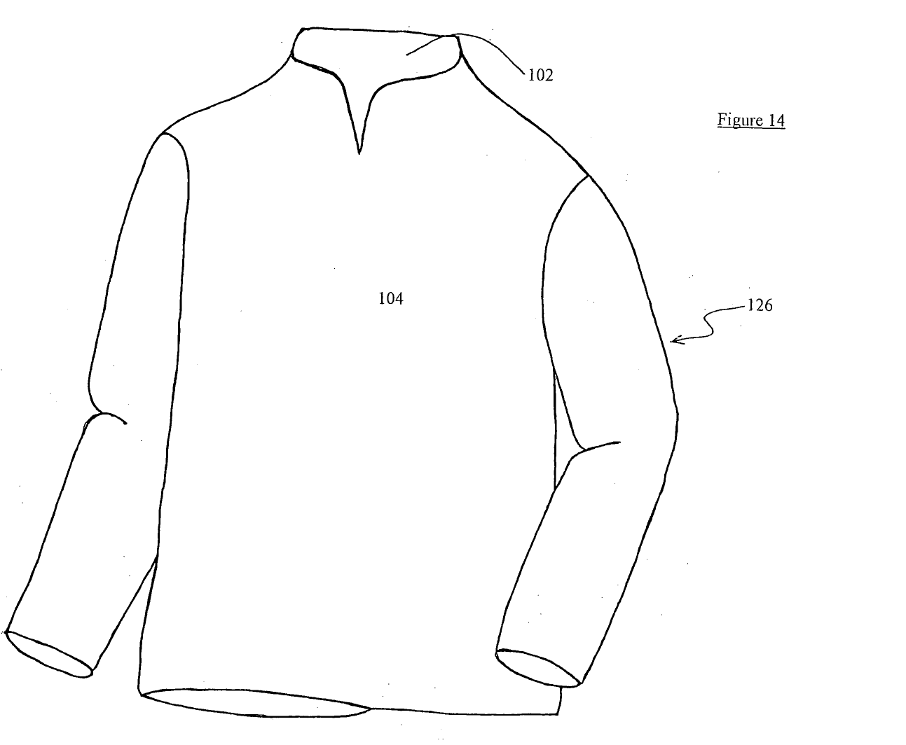

FIG. 14 shows the shirt of FIG. 13, only with the reflective layer 104 worn away from the skin to reflect the sun's intense rays and keeps the wearer cooler.

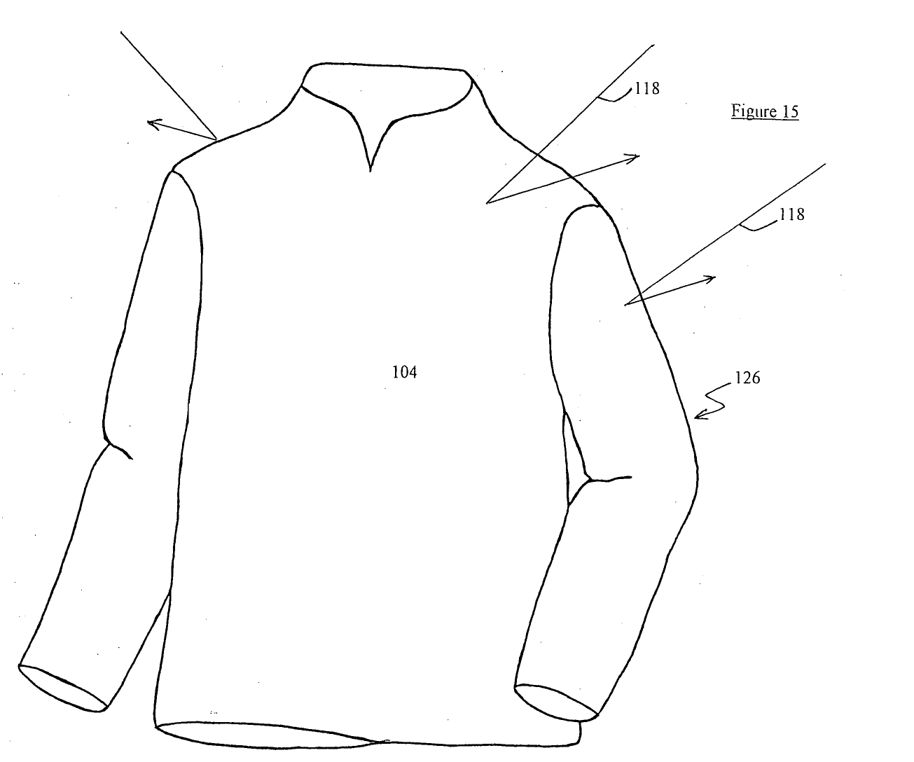

FIG. 15 depicts the reflection of the thermal radiation (in this case sunlight) 118 from the reflective layer 104 of a shirt 126 according to one embodiment of the present invention.

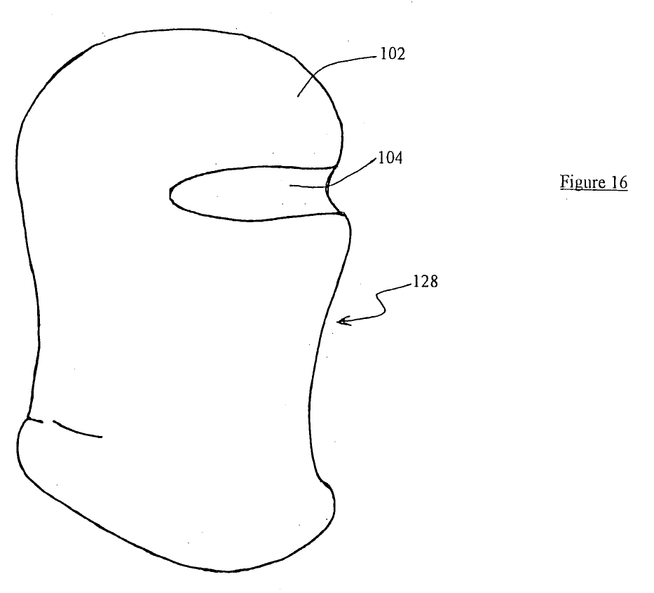

FIG. 16 shows a balaclava 128 made of the Material 100. It is noted that the balaclava of FIG. 16 could be worn alone or as an additional protective layer under the hood of a jacket.

As noted above, one embodiment of the present invention is for use in the manufacture of sleeping bag covers/liners/bivy sacs, sunscreens, and outdoor clothing, either as garments themselves or as protective layers incorporated within said outdoor clothing.

As a bivy or sleeping bag cover, the current invention would provide a layer of water resistance, thermal reflectivity (warmth) and protection to sleeping bags from moisture, dirt and abrasion.

As a sleeping bag liner, the current invention would add a layer of thermal reflectivity (additional warmth) to the sleeper while allowing body moisture to pass out of the sleeping bag, increasing sleeping comfort.

As a stand alone sleeping bag/bivy, the present invention would provide more warmth than other non-reflective fabrics and superior breathability to non-porous materials and other non-breathable coated materials.

### OTHER EMBODIMENTS OF THE INVENTION

Use of the presently described fabric also results in a method and process. Although the present invention is designed for use in conjunction to the articles listed above, the present invention also contemplates use in conjunction with any device having suitable shapes or sizes.

Other applications of the present invention include, but are not limited to lightweight, inexpensive, easy-to-clean-and-store blankets for motor homes, hotels, motels and even third world countries.

Ultimately, while the invention has been described in connection with a preferred embodiment, the description provided herein is not intended to limit the scope of the invention to the particular form set forth, but, on the contrary, is intended to cover such alternatives, modifications, and equivalents as may be included within the spirit and scope of the invention as defined by the appended claims.

What is claimed:

1. A water resistant thermal insulating material comprising:
a) an underlying layer; and
b) a thermally reflective coating disposed on the underlying layer, wherein either the underlying layer or coating is water resistant.

2. The material of claim 1, wherein the underlying layer is olefin.

3. The material of claim 1, wherein the thermally reflective coating is aluminum.

4. A method of making a desired article comprising:
a) providing a water resistant thermally insulated material having:
i) an underlying layer; and
ii) a thermally reflective coating disposed on the underlying layer, wherein wither the underlying layer or coating is water resistant; and
b) fashioning the material into the desired article.

5. The method of claim 4, wherein the underlying layer comprises olefin.

6. The method of claim 4, wherein the coating is aluminum.

7. The method of claim 4, wherein the article is a poncho.

8. The method of claim 4, wherein the article is a hat.

9. The method of claim 4, wherein the article is a mitten or glove.

10. The method of claim 4, wherein the article is a shirt.

11. The method of claim 4, wherein the article is a cover such as a sleeping bag cover, liner, bivy, or blanket.

12. A reversible article having a first and second face, the article comprising:
a) a first face having an underlying material; and
b) a second face having a thermally reflective coating disposed on the underlying material, wherein either the underlying material or coating is water resistant; and wherein the first face can be turned outwardly when thermal radiation is desired to be reflected inwardly, and wherein the first face can be turned outwardly when thermal radiation is desired to be reflected outwardly.

13. The article of claim 12, wherein the article is a poncho.

14. The article of claim 12, wherein the article is a hat.

15. The article of claim 12, wherein the article is a mitten.

16. The article of claim 12, wherein the article is a shirt.

17. The article of claim 12, wherein the article is a cover such as a sleeping bag cover, liner, bivy, or blanket.
